(19) United States
(12) Patent Application Publication
(10) Pub. No.: US 2018/0357144 A1
(43) Pub. Date: Dec. 13, 2018

(54) COMPUTER IMPLEMENTED METHOD FOR GENERATING SUSTAINABLE PERFORMANCE AND ENVIRONMENTAL IMPACT ASSESSMENT FOR TARGET SYSTEM

(71) Applicant: Bionova Oy, Helsinki (FI)

(72) Inventor: Panu PASANEN, Helsinki (FI)

(21) Appl. No.: 15/618,025

(22) Filed: Jun. 8, 2017

(51) Int. Cl. G06F 11/34; G06F 11/30

(52) U.S. Cl. CPC G06F 11/3452; G06Q 50/08; G06F 2219/10; G06F 11/3013

(57) ABSTRACT

A computer implemented method for generating sustainable performance and environmental impact assessment for a target system, comprising: receiving input data associated with the target system; receiving sustainable performance and environmental assessment rules of the target system; generating assessment dataset containing a plurality of data items based on the received input data; determining applicable impact assessment data for each of the data items in the assessment dataset using dynamic adaptive recognition data comprising pre-configured recognition data; applying the applicable impact assessment data for each of the data items in the assessment dataset to generate an impact dataset; and determining sustainable performance and environmental impact assessment information of the target system using the sustainable performance and environmental assessment rules and the impact dataset.

### TECHNICAL FIELD

The present application generally relates to a method and a system for providing life cycle assessment (LCA) service and tools. The present application further relates to a method and a system for providing life cycle costing (LCC) service and tools.

### BRIEF DESCRIPTION OF RELATED DEVELOPMENTS

Construction is the world's largest industry in terms of resource usage and waste generation, and buildings are the largest user of energy and driver for global warming. Improving resource efficiency and environmental impacts are widely considered the main challenges of the construction industry.

Life Cycle Assessment (LCA) tools assess e.g. building's or building product's environmental performance, and are necessary to design and build in an environmentally sustainable manner. However, currently there are no fast, affordable and scalable LCA tools. LCA study usually is high-cost and takes 40-150 hours, delaying the construction process and slowing the uptake of LCA. Economies of scale have not been achieved due to heterogeneous requirements in various certifications and regulations as well as heterogeneous input datasets.

Some higher performing buildings increase initial capital cost but create operational savings. To be able to make a decision on a project, long term cost perspective should be considered. Life cycle costing (LCC) tools assess building's financial performance over its life cycle. Combining LCA with LCC allows optimizing environmental sustainability and financial performance simultaneously.

Thus, a solution is needed to enable faster, more reliable and more flexible Life Cycle Assessment (LCA) and/or and Life Cycle Costing (LCC).

### SUMMARY

According to a first example aspect of the disclosed embodiments there is provided a computer implemented method for generating sustainable performance and environmental impact assessment for a target system, comprising:
receiving input data associated with the target system; converting the input data comprising raw material data to a universal system specification data format suitable for sustainable performance and environmental impact assessment;
receiving sustainable performance and environmental assessment rules of the target system;
generating assessment dataset containing a plurality of data items based on the converted input data;
determining applicable impact assessment data for each of the data items in the assessment dataset using dynamic adaptive recognition data comprising pre-configured recognition data;
applying the applicable impact assessment data for each of the data items in the assessment dataset to generate an impact dataset; and
determining sustainable performance and environmental impact assessment information of the target system using the sustainable performance and environmental assessment rules and the impact dataset.

In an embodiment, the dynamic adaptive recognition data further comprises user generated recognition data.

In an embodiment, the applicable impact assessment data are determined by selecting available impact assessment data that comply with the sustainable performance and environmental assessment rules of the target system.

In an embodiment, the dynamic adaptive recognition data comprises data recognition rules or patterns.

In an embodiment, the dynamic adaptive recognition data utilizes a plurality of different languages, character sets or encoding methods.

In an embodiment, the user generated recognition data comprises recognition patterns generated based on user behaviour.

In an embodiment, the method further comprises scoring data recognition patterns of the dynamic adaptive recognition data to identify candidate data for determining the applicable impact assessment data, wherein the scoring utilizes user parameters comprising at least one of the following: geographical location information, user information, company information and target system information.

In an embodiment, the method further comprises:

determining if no applicable dynamic adaptive recognition data exist;

allowing a user to determine impact assessment data for the target system; and

generating dynamic adaptive recognition data using the user determined impact assessment data.

In an embodiment, the method further comprises adjusting at least one data item of the applicable impact assessment data to generate adjusted impact assessment data, wherein the adjusted impact assessment data is configured to represent product or process impacts within applicable geographic location or specific process for the target system.

In an embodiment, unit of at least one data item of the assessment dataset is converted from a first unit to a second unit.

In an embodiment, the received input data associated with the target system comprises heterogeneous input data from a plurality of information sources.

In an embodiment, the heterogeneous input data comprises material data of a plurality of data formats.

In an embodiment, the method further comprises detecting erroneous data items from the plurality of data items of the assessment dataset considering the sustainable performance and environmental assessment rules of the target system or a dynamic system data quality reference comprising rules and patterns.

In an embodiment, the method further comprises:

correcting at least one error of the assessment dataset based on detected erroneous data items; and

generating a corrected assessment dataset to replace the assessment dataset.

In an embodiment, the method further comprises:

filtering the assessment dataset based on the sustainable performance and environmental assessment rules to generate filtered system specification data, wherein a portion of the assessment dataset that is not applicable for the sustainable performance and environmental assessment rules is removed; and

generating a filtered assessment dataset to replace the assessment dataset.

In an embodiment, the method further comprises filtering the assessment dataset based on the sustainable performance and environmental assessment rules to generate filtered system specification data, wherein a portion of the assessment dataset that is not applicable for the sustainable performance and environmental assessment rules is removed; and generating a filtered assessment dataset to replace the assessment dataset.

In an embodiment, unit of at least one data item of the assessment dataset is converted from a first unit to a second unit; and the method further comprises enhancing the assessment dataset based on the sustainable performance and environmental assessment rules of the target system or the dynamic system data quality reference comprising rules and patterns for classifying or adding assessment parameters to the data items.

In an embodiment, the method further comprises scoring the applicable impact assessment data for fulfilling functional or technical criteria comprising at least one of the following: fire classification, accessibility classification, health-impacting emission classification, cost performance classification and climate resiliency classification.

In an embodiment, the received input data associated with the target system comprises heterogeneous input data from a plurality of information sources, and the method further comprising determining input data, consisting of data items wherein at least one of the data items is a composite data item configured to consist of multiple materials and to be broken down to constituent parts.

In an embodiment, the method further comprises determining input data, consisting of data items with multiple materials being described in form of composites, configured to break down to constituent parts or to be processed as pre-fabricated or on-site construction elements.

In an embodiment, the pre-configured recognition data comprises data recognition rules or patterns.

In an embodiment, the data recognition rules or patterns comprise at least one of wildcard character information, similarity pattern and terminology information utilizing a plurality of different languages or technical encoding systems.

In an embodiment, the method further comprises:

determining geographical location information for the target system; and

applying the available impact assessment data for each of the data items in the assessment dataset to generate an impact dataset using the geographical location information.

According to a second example aspect of the disclosed embodiments there is provided an apparatus comprising:
a communication interface;
at least one processor; and
at least one memory including computer program code;
the at least one memory and the computer program code configured to, with the at least one processor, cause the apparatus to:
   receive input data associated with the target system;
   convert the input data comprising raw material data to a universal system specification data format suitable for sustainable performance and environmental impact assessment;
   receive sustainable performance and environmental assessment rules of the target system;
   generate assessment dataset containing a plurality of data items based on the converted input data;
   determine applicable impact assessment data for each of the data items in the assessment dataset using dynamic adaptive recognition data comprising pre-configured recognition data;
   apply the applicable impact assessment data for each of the data items in the assessment dataset to generate an impact dataset; and
   determine sustainable performance and environmental impact assessment information of the target system using the sustainable performance and environmental assessment rules and the impact dataset.

According to a third example aspect of the disclosed embodiments there is provided a computer program embodied on a computer readable non-transitory medium comprising computer executable program code, which when executed by at least one processor of an apparatus, causes the apparatus to:
receive input data associated with the target system;
convert the input data comprising raw material data to a universal system specification data format suitable for sustainable performance and environmental impact assessment;
receive sustainable performance and environmental assessment rules of the target system;
generate assessment dataset containing a plurality of data items based on the converted input data;
determine applicable impact assessment data for each of the data items in the assessment dataset using dynamic adaptive recognition data comprising pre-configured recognition data;
apply the applicable impact assessment data for each of the data items in the assessment dataset to generate an impact dataset; and
determine sustainable performance and environmental impact assessment information of the target system using the sustainable performance and environmental assessment rules and the impact dataset.

Different non-binding example aspects and embodiments of the disclosure have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

The aspects of the disclosed embodiments will be described, by way of example only, with reference to the accompanying drawings, in which:

FIG. 1 shows a schematic picture of a system according to an example embodiment of the present disclosure;

FIG. 2 shows a schematic diagram of a system server providing dynamic data objects or data entities according to an example embodiment of the present disclosure;

FIG. 3 presents an example block diagram of an apparatus in which various embodiments of the present disclosure may be applied. This may be a user device or apparatus, such as a laptop, a desktop, a mobile terminal or other communication device;

FIG. 4 shows a flow diagram showing operations in accordance with an example embodiment;

FIG. 5 shows another flow chart of exemplary method steps for providing a computer implemented method for generating sustainable performance and environmental impact assessment for a target system; and

FIG. 6 shows an example block diagram of a network level information platform (NIP) for a computer implemented method for generating sustainable performance and environmental impact assessment for a target system according to an example embodiment of the present disclosure.

### DETAILED DESCRIPTION

In the following description, like numbers denote like elements.

Technical effect of the embodiments of the invention is that Life Cycle Assessment (LCA) and sustainable performance assessment can be done much faster (with one click) and it costs much less. A core element of the system is an innovative data interface with an adaptive recognition engine. It can be easily trained by the user to adapt to their particular data, enabling automatic processing of any data sources. Unlike prior known solutions, it also allows building tailor-made sustainability applications, resolving the issue of diversity in LCA-related requirements. Unlike prior known solutions, it also allows dynamic system generated data for LCA as well as multiple user-generated data to be used for LCA related automatic assessment procedures.

The systems and techniques described here relate to dynamic sustainable performance and environmental impact assessment for a target system.

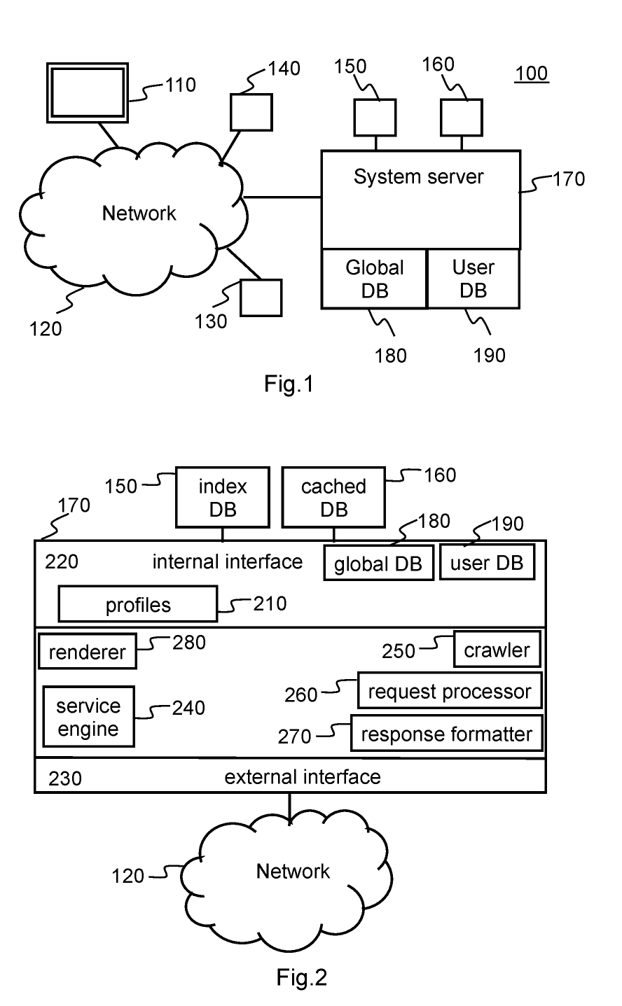

FIG. 1 shows a schematic picture of a system 100 for dynamic sustainable performance and environmental impact assessment according to an example embodiment of the present disclosure. The system 100 includes an apparatus 110, shown as a portable computer for communicating with a user, but could take any appropriate form, such as a cellular telephone handset, personal digital assistant, a tablet, a phablet, a personal computer, or a voice-driven communication device. Apparatus 110 may obtain the information the user needs through network 120 that may be a single network or combination of networks. Apparatus 110 may also generate information. A dynamic LCA service system server 170 may also communicate with the network 120 to receive data object requests from the apparatus 110 and locate information to return to the apparatus 110. The server 170 may be of any applicable form. The system 100 does not require all elements disclosed but as minimum, merely the apparatus 110 is required.

Among other components included in the system server 170 there may be a global database 180, a user database 190, an index database 150 and a cached information database 160. The global database 180 contains sustainable performance and environmental impact assessment related data that is available to all users of the service system 100, for example public data, public material data, public timelines, public data entities, public work objects, pattern data, rules, filter related data, and collaborators. The user database 190 contains data that is available only to the dedicated user of the service system 100, for example private data, private timelines, private data entities, work objects, collaborators and user profile information. The index database 150 contains data that represent searchable information available to the service system 170. For example, the system server 170 may scan the internet, intranets, collaboration or co-operation servers or various databases for content such as web sites, service providers, external indexes or workgroup discussions, may extract key words and other objects from the content, and may organize the information in a manner that permits ready searching and retrieval. The index database 150 may also generate other information from the content, such as indicators of how certain web sites link to other web sites, and other related metadata. Dynamic sustainable performance and environmental impact assessment related data may also be transferred between the databases 180, 190. For example, a user having copy rights may copy a data entity from the global database 180 to the user database 190.

In an example embodiment of the present disclosure, the cached information database 160 contains copies or substantial copies of content that the service system 170 locates. In this manner, a user who accesses system 170 may request the cached information rather than making direct connection with the content provider, such as when the content provider is inaccessible, has changed the content since it was cached, or when the connection to the content provided is substantially slower than that to the dynamic service system 170. Service system 170 may also be used to provide partial or subsets of information or combinations of information that may be preferable, in some cases, to full web content directly from source systems.

In an example embodiment, history data of the service system 100 may be stored to the cached information database 160.

The dynamic LCA service system 100 may also include other nodes 130, 140 connected to the network 120 or directly with the apparatus 110. These nodes 130, 140 could include any sort of device or devices capable of communicating with or over the network 120 or the apparatus 110. For example, node 130 could be a user apparatus monitoring a co-operation project status between two companies, for example by monitoring a data entity generated by a target system development application, such as project plan information generated by a development application and defined by the user of the apparatus 110. Node 130 may also be a device for receiving any target system related data of any data format. Node 130 may also be a web server that is capable of delivering content in response to requests by users or nodes, such as a user of the apparatus 110, or deliver content automatically based on a variety of attributes and variables. As another example, node 140 could be an external service provider that may be accessed by the apparatus 110 or the dynamic service server 170.

In an embodiment, a computer-implemented method comprises receiving input data, at the apparatus 110, associated with a target system and receiving sustainable performance and environmental assessment rules (e.g. LEED, Leadership in Energy and Environmental Design) of the target system internally within the apparatus 110 or over the network 120 from an external node, such as the system server 170 or nodes 130, 140.

Input data may be received from a plurality of information sources, such as databases, software modules, network services and devices.

In an embodiment, the computer implemented method may provide a plurality of options for data integration.

First, file-based integration is available. Integrating computer implemented algorithm produces a data file suitable for uploading to LCA system. The data transfer may be done by the end user.

Second, one way communication is available. Integrating computer implemented algorithm produces a data file suitable for uploading to LCA system, and sends the data to a server for calculation. The integrating software may open a browser window, in which results are provided to the end user, and where the user can modify the calculation data and assumptions.

Third, two way communication is available. Integrating software produces a data file suitable for uploading to LCA system, and sends the data to the server for calculation together with calculation instructions. The calculation results are sent back to the integrating software in form of a results file and integrating software provides them to the user. The user is able to modify calculation data in integrating software only.

In an embodiment, heterogeneous input data may comprise material data of a plurality of data formats. For example, method for handling multi-constituent inputs (such as concrete sandwich wall element, containing concrete, steel and insulation) is provided and thus allowing each constituent to be applied their appropriate impact factors.

In an embodiment, input data is processed or broken down to determine data items consisting of items with multiple materials being described in form of composites to constituent parts either automatically or with user assistance. For example, reinforced concrete consisting steel and concrete, or concrete wall element consisting of steel, concrete and insulate and possibly a membrane may be determined. Alternatively, it may be processed as pre-fabricated or on-site construction elements.

The method then includes generating assessment dataset containing a plurality of data items based the received input data, determining available impact assessment data (e.g. factors) for each of the data items in the assessment dataset using dynamic adaptive recognition data comprising at least one of pre-configured recognition data and user-generated recognition data. After that, the method comprises applying the available impact assessment data for each of the data items in the assessment dataset to generate an impact dataset, and determining sustainable performance and environmental impact assessment information of the target system using the sustainable performance and environmental assessment rules and the impact dataset. Based on the determined sustainable performance and environmental impact assessment information of the target system a report may be generated. The report may be transmitted or indication of it, to designated users through network 120 as a service result. For example, the returned information may also be transcoded to appropriate format for processing in the apparatus 110, such as HTML code, XML messages, JavaScript object notations (JSONs), xhtml, plain text, PDF, RTF, Word document, Excel or such.

In an embodiment, the method further comprises scoring data recognition patterns of the dynamic adaptive recognition data to identify candidate data for determining the applicable impact assessment data, wherein the scoring utilizes user parameters comprising at least one of the following: geographical location information, user information, company information and target system information. The target system information may comprise data on optimal product for the project considering regional availability as well as economic, functional and technical factors.

In an embodiment, adjusted impact assessment data is configured to represent product or process impacts within chosen geographic location or specific process. Compensation (adjustment) is configured to allow for a comprehensive range of regional differences e.g. grid-mix, production, technological, resource availability, transport and waste disposal routes. The compensation may be utilized at a product level.

In an embodiment, the method further comprises detecting erroneous data items from the plurality of data items of the assessment dataset considering the sustainable performance and environmental assessment rules of the target system or a dynamic system data quality reference comprising rules and patterns. Furthermore, alerts (for at least one user or associated data system) may be generated in response to detecting erroneous data items.

Processing of the input data may comprise processing additional parameters. The additional parameters may comprise type of material or structure, its classification, thickness, transportation distance, manufacturer or other descriptions, for example.

Furthermore, container type objects may be removed from input data. There exist many kinds of container objects that are simply grouping other materials or objects. They do not have their own materials or independent volume and would create duplication of data. Such data may be filtered out by the computer implemented method.

In an embodiment, the assessment dataset may be enhanced based on the sustainable performance and environmental assessment rules of the target system or the dynamic system data quality reference comprising rules and patterns for classifying or adding assessment parameters to the data items. The assessment parameters may comprise additional informative parameters or classification parameters, for example.

In an embodiment, the applicable impact assessment data may be scored for fulfilling the functional and/or technical criteria, including but not limited to fire classification, accessibility, architectural and aesthetic, health and emissions classification, structural performance, acoustic performance, and climate resiliency. The applicable impact assessment data may also be scored for fulfilling the cost performance requirements, or regional availability of the specific resource, or combination thereof, where transport cost of the resource to the required location is also considered.

FIG. 2 shows a schematic diagram of a system server 170 providing dynamic data objects or data entities according to an example embodiment of the present disclosure. The system server 170 may receive and/or transmit requests, generate responses to the requests, and generate data entities based on certain criteria, for example different profile information, data, algorithms and such. The service system server 170 is connected to a network 120, such as the internet, to be able to communicate with users who may be interested in accessing the services provided by dynamic the service system server 170. The dynamic service system server 170 may be broken into multiple separate systems to allow for scalability, and may be connected to network 120 in any of a variety of ways, as is commonly known.

The service system server 170 may include a global database 180 and a user database 190. Furthermore the service system server 170 may also include an index database 150 and a cached information database 160. These databases 150, 160, 180, 190 may be connected to service system server 170, for example, by a high bandwidth LAN or WAN, or could also be connected to the search system server 170 through network 120. The databases may also be located in the same location as the server 170 or split up so that they are located in multiple locations. The databases, or parts of them, may also be comprised within the apparatus 110, for example.

The system server 170 may communicate through an internal interface 220 and an external interface 230, which are shown as distinct interfaces, but may be partially or fully combined, or may be represented by additional interfaces. For example, internal interface 220 may comprise interface devices for a high speed, high bandwidth network such as SONET, Infiniband, or Ethernet network cards, or any appropriate communication hardware operating under an appropriate protocol, so that dynamic service system server 170 can respond to a large number of distinct dynamic requests simultaneously. External interface 230 may comprise interface devices for communicating with network 120, such as Ethernet network interface cards (NICs) or other communications devices. The precise design of the service system server 170 could take any appropriate form.

Within the service system server 170, a service engine 240 operates to produce dynamic service results in response to dynamic service requests, input or feedback from users, employing information stored in databases 150, 160, 180, 190. The information in index or global database 150 may be gathered by a crawler 250, which may continuously or almost continuously obtain new information from sources connected to network 120. A renderer 280 may be included in the service system server 170 for rendering data object related information according to system specific format. Rendering may be done also in the crawler 250, in the service engine 240 or in the external interface 230. Service requests of the dynamic sustainable performance and environmental impact assessment system may be received through the external interface 230 and handled by the request processor 260. For example, request processor 260 may parse the requests and reformat them, for example from html/text requests to internally usable search terms/strings. The dynamic information, such as data entities relating to determining sustainable performance and environmental impact assessment information of the target system generated by the service engine 240 in response to a request may also be converted by response formatter 270 in a manner that allows it to be used by the requesting device, such as in HTML code, XML messages, JavaScript object notations (JSONs), xhtml, plain text, PDF, RTF, Word document, Excel or such, and then transmitted via external interface 230.

Sustainable performance and environmental impact assessment information related input data may be retrieved and/or generated by the service engine 240, which may monitor requests from a user, responses to the user or any number of requests and responses not exclusively related to a particular user. To clarify, these requests and responses may be generated by internal or external systems and services. In this manner, the service engine 240 is able to begin working as soon as a request is received or a response is delivered, either from a user of the system 100, or from other system components or external systems. For example, where a dynamic business network and data management service request is received by the service system 170, that request may be processed and forwarded to service engine 240. In addition, the service engine 240 may recognize the request, and cause additional formatted requests to be forwarded to the service engine. The service engine 240 may cause the sustainable performance and environmental impact assessment information of the target system that results from those requests to be transmitted to the user's apparatus or external services, for example, using response formatter 270.

The service engine 240 may include, for example, context centric applications, algorithms, service parameters, data entities and dynamic service engine. The service parameters may include parameters that may be selected and changed to manage the manner in which dynamic service information is gathered. The rules may be specific to particular users or accounts (e.g., in a profile of rules for the user, or with pointers for a user to particular parameters to minimize storage space required).

The system server 170 may continually learn from users and it is possible to build a dedicated index, for example a content matching engine, based on the data passing through the system. Such index may be located in the index database 150. It is also possible to use any available public or proprietary index, for example but not limited to, an openly available index on the Internet or a corporate database within a corporate intranet.

In one embodiment of the present disclosure the dynamic profile information may contain several types of attributes. Profile information for the users may be located in system storage block 210 of FIG. 2. Profile information may also be located in the user database 190 or in the global database 180. Profiles 210 may also connect to other users and systems, including both internal and external users and systems. Profiles and filters may be adapted and applied to external systems, partially or wholly, and external profile information and/or filter information may be adapted and applied, either partially or wholly, to internal profiles and filters.

Typically, an account within the system is defined for a company and certain users within that particular company may use the account.

In an embodiment, pattern data is defined by the service system data mining based on the co-operation and networking data processed by the system.

In an embodiment, the system server 170 may store all data entities related to the context centric applications and perform pattern data mining. Thus, certain patterns may be detected in organizational, project or data entity level, as well as company, group or certain location level, for example.

In an example embodiment of the present disclosure, the service system described in FIGS. 1 to 2 may be applied to various purposes, for example enterprise dynamic co-operation data management, networking between companies, cross-company co-operation data management, LCA data management or personal dynamic data management.

In enterprise data management, the dynamic service system may provide any dynamic service based on company and/or employee needs, for example project management, sourcing, product development, manufacturing, billing and auditing. User profile information may be applied to enterprise usage. There are vast amount of information contained in corporate intranets, corporate database systems and related systems. For example in customer relationship management tools, project management tools, requirements management tools, enterprise resource planning tools, product data management tools, communications tools, marketing tools, strategic planning tools, financial tools and additionally in relevant external data sources. However, this information is often under-utilized as companies, and their employees face difficulties in providing and/or discovering and/or sharing the most relevant and beneficial data entities in a timely manner. The ability to increase the efficiency and/or enjoyment of this represents a significant opportunity to increase productivity and competitiveness in enterprises. Based on the co-operation data, forecasts may be made, for example. Pattern data mining may enable to provide LCA assessment of outcomes of ongoing projects with certain input data and collaborators, for example.

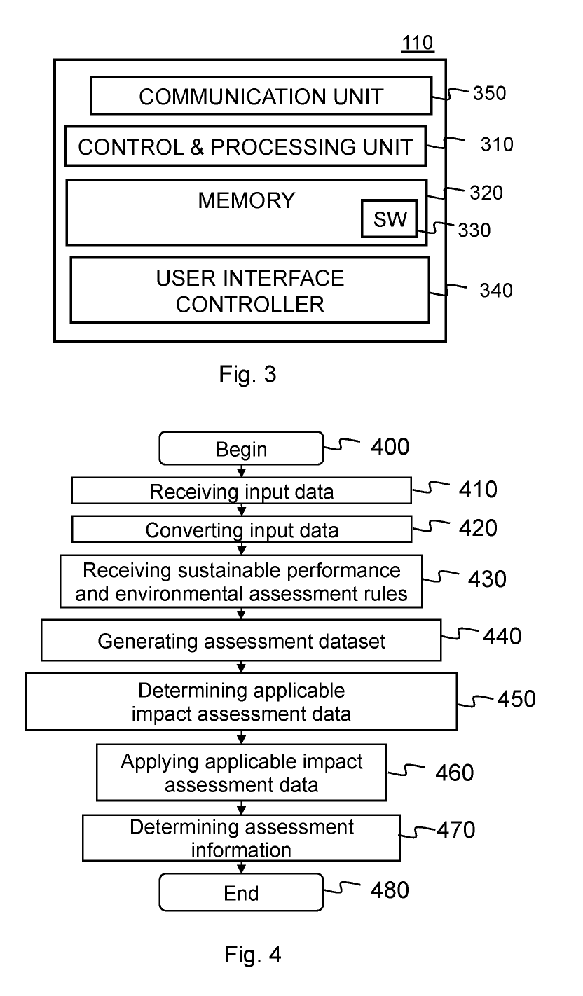

FIG. 3 presents an example block diagram of an apparatus 110 in which various embodiments of the present disclosure may be applied. This may be a user device or apparatus, such as a laptop, a desktop, a mobile terminal or other communication device.

The general structure of the apparatus 110 comprises a communication interface module 350, a processor 310 coupled to the communication interface module 350, and a memory 320 coupled to the processor 310. The apparatus 110 further comprises software 330 stored in the memory 320 and operable to be loaded into and executed in the processor 310. The software 330 may comprise one or more software modules and can be in the form of a computer program product. The apparatus 110 further comprises a user interface controller 340 coupled to the processor 310.

The communication interface module 350 implements at least part of the user data communication discussed in connection with various embodiments of the present disclosure. The communication interface module 350 may be a wired broadband interface module such as LAN or WAN. The communication interface module 350 may also be, e.g., a radio interface module, such as a WLAN, Bluetooth, GSM/GPRS, CDMA, WCDMA, LTE (Long Term Evolution) or 5G radio module. The communication interface module 350 may be integrated into the apparatus 110 or into an adapter, card or the like that may be inserted into a suitable slot or port of the apparatus 110. The communication interface module 350 may support one radio interface technology or a plurality of technologies. FIG. 3 shows one communication interface module 350, but the apparatus 110 may comprise a plurality of communication interface modules 350.

The processor 310 may be, e.g., a central processing unit (CPU), a microprocessor, a digital signal processor (DSP), a graphics processing unit, or the like. FIG. 3 shows one processor 310, but the apparatus 110 may comprise a plurality of processors.

The memory 320 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The apparatus 110 may comprise a plurality of memories. The memory 320 may be constructed as a part of the apparatus 110 or it may be inserted into a slot, port, or the like of the apparatus 110 by a user. The memory 320 may serve the sole purpose of storing data, or it may be constructed as a part of an apparatus 110 serving other purposes, such as processing data.

The user interface controller 340 may comprise circuitry for receiving input from a user of the apparatus 110, e.g., via a keyboard, graphical user interface shown on the display of the apparatus 110, speech recognition circuitry, or an accessory device, such as a headset, and for providing output to the user via, e.g., a graphical user interface or a loudspeaker.

A skilled person appreciates that in addition to the elements shown in FIG. 3, the apparatus 110 may comprise other elements, such as microphones, displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the apparatus 110 may comprise a disposable or rechargeable battery (not shown) for powering the apparatus 110 when external power if external power supply is not available.

FIG. 4 shows a flow chart of exemplary method steps for providing a computer implemented method for generating sustainable performance and environmental impact assessment for a target system.

The method begins at step 400. In step 410, input data associated with the target system is received. In step 420, the input data comprising raw material data is converted to a universal system specification data format suitable for sustainable performance and environmental impact assessment. In step 430, sustainable performance and environmental assessment rules of the target system are received. In step 440, assessment dataset is generated containing a plurality of data items based on the received input data. In step 450, applicable impact assessment data is determined for each of the data items in the assessment dataset using dynamic adaptive recognition data comprising pre-configured recognition data. In step 460, the applicable impact assessment data are applied for each of the data items in the assessment dataset to generate an impact dataset. In step 470, sustainable performance and environmental impact assessment information of the target system are determined using the sustainable performance and environmental assessment rules and the impact dataset. In step 480, the method ends.

The above mentioned flow chart is exemplary and the steps may take other order depending of the use of the system.

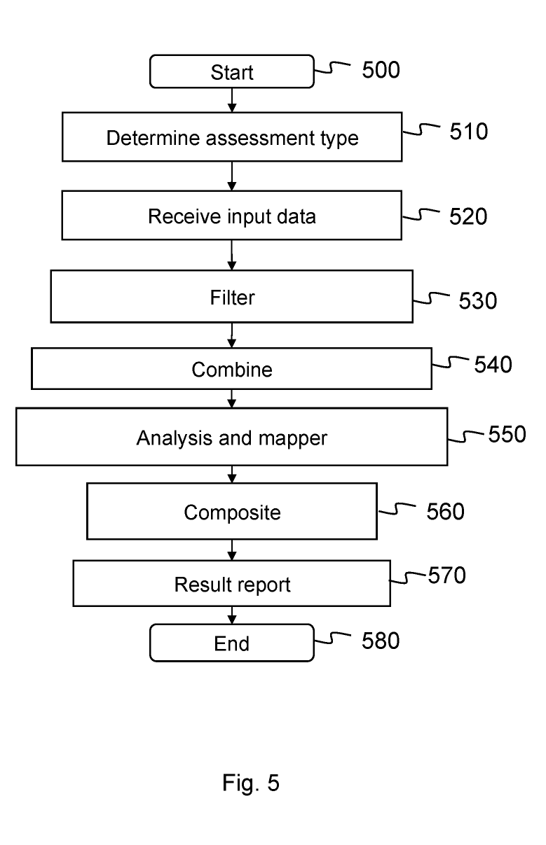

FIG. 5 shows another flow chart of exemplary method steps for providing a computer implemented method for generating sustainable performance and environmental impact assessment for a target system.

The method starts in step 500. In step 510, based on user input it is determined which type of assessment is processed and it may be determined based on user input if fully automatic or semiautomatic process is determined. In semi-automatic process user may be involved during the process.

In step 520, input data is received. The received input data may comprise heterogeneous input data from a plurality of databases, designs and sources. Allowed input data formats may comprise, for example:
Data representing any product system: spreadsheet data (e.g. Excel), XML, JSON
Data representing building energy models: XML, gbXML
Building design files: IFC2×3, IFC4, Revit, ArchiCAD, Tekla Structures, SketchUp
Infrastructure design files: IFC2×3, IFC4, LandXML, INFRAModel

In step 530, filtering is done. Filtering is done for the heterogeneous input data based on target product system to provide information for analysis of the target product or construction work, for example. Filtering is based on the type of assessment required, for example, a regulatory assessment in California will have different filtering than commercial LEED (Leadership in Energy and Environmental Design) assessment anywhere in the US. This is the basis for a first filtering based on the required scope of the assessment (e.g. as LEED assessment does not consider building technology or external areas those may be left out from the input data). Filtering enables cleaning up the data and makes it possible to run the process. Otherwise the process may not work automatically as the amount of data would be too high.

In an embodiment, the filtering step 530 may also comprise error detection and correction. Detecting and correcting errors and inconsistencies within the heterogeneous input data may be done using dynamic reference system data and patterns. These steps may be done in three parts, as follows.

First, it is determined, which data is erroneous and can be discarded. First it is determined based on the SIGNIFICANCE on the input (e.g. data labelled Airspace is left out). Then it is determined based on the VALIDITY of the input (e.g. data like inputs of zero quantity are left out).

Discard rules may also arise from user behaviours. So if users consistently discard a label XXXX the system will be learned to automatically discard such label later on.

Second, unit conversions are processed. For example, if a user gave inputs in M3 but target system requires KG, then conversion is made using the technical parameters, such as density, of each individual resource or material. Unit conversion may be needed because impact assessment data are not necessarily provided in same unit.

Third, classification information is applied, such as information required by the target system. For example, BREEAM requires that each material input is classified using RICS New Rules of Measurement classification or French regulation has it's own classification. So an automatic classification is done.

As a substep minor spelling mistakes may be corrected, or some wildcards, similarity patterns or multi language inputs may be utilised too.

Dynamic adaptive recognition data may comprise at least one of wildcard character information, similarity pattern and terminology information utilizing a plurality of different languages.

In step 540, combining is done. Combining may comprise combining data groups that can be recreated by user defined parameters dynamically. The system may show details of all rows that are proposed to be combined in the user interface view, if desired. Also, combined data and also all uncombined data may be able to carry forward their descriptive fields to the import process. Combining can be done automatically, or user may apply ad hoc combine criteria.

In step 550, analysis and mapper is disclosed. In this step of the process, data quality issues are defined specifically. The mapper may need a localisation filter for mapping. Locality is known from the chosen project in the beginning of the process as discussed. The mapper may only present single time the choices that are not identified, not repeating each time. It is possible for the mapper to be able to export the data (e.g. spreadsheet data), for example.

Appropriate impact assessment data may be applied for the target product or construction work based on the heterogeneous input data for the necessary datasets. In an embodiment, the system does not require the user to define the data in any specified way. In stark contrast, the system software with algorithms defined carries out needed steps together with a memory and a processor. The sub-steps of step 550 may comprise, as follows:

First, the process determines what are the acceptable assessment data for purpose of the assessment (for example, commercial LEED certification requires data to comply with ISO 14044 standard exclusively).

Second, determination is made in this order of preference, what recognition patterns are available, for example:
Hard wired patterns like codes
User created patterns
User's company patterns
System level patterns
Cost efficiency patterns
Patterns from any user in the same country
Patterns from users anywhere

For some patterns, wildcards may be possible (like Steel*).

If at least one recognition pattern is positive, then it means that assessment can be performed for a dataset. If multiple patterns exist, the strongest pattern may be applied.

Third, all ambiguities that may exist are identified and reported automatically so that patterns may be generated for them (to user, to admin, to SW).

In step 560, composite material processing is done. Composite materials can be broken to constituent parts or handled as constructions.

Impact assessment information of the target building system may be determined based on the impact data. The system may apply life-cycle stage calculations for all incoming data based on the requirements of the target system. For example, LEED, Leadership in Energy and Environmental Design requires considering manufacturing, transport to construction site, repair replacement and maintenance for 60 years, and end of life processing. The process calculates all these life-cycle stage steps from the data representing initial material inputs bought for the investment as disclosed.

In step 570, a result report is generated. At the same time a feedback screen may be shown to the user of the apparatus. Such feedback screen may also be shown while the results are processed and report results of each suboperation in one row of message, such as:
Filtering by LCA for LEED—done. Removed XX
Combining by XXX—done. Combined xxx
Analysis—done. Discarded xxx.

In step 580, the process ends.

In an embodiment, structure learning data into sets may be applied during the process, for example in combining step 540. All data is regarded to be in a set or belong to a set. Mapping may be simplified so that they contain reference of the account of the user and the organisation (if given) as well as Functional Equivalent. The amount of data stored in the mappings may be reduced and any new created mapping may also store the country of the project.

Multiple mappings may be made possible for the same entry. Thus, for example users can have their own mappings that override the settings of other users and there can be multiple mappings from multiple countries.

In an embodiment, a plurality of possible types/parameters for sets of learning data may comprise:
A) Map (user)—typical set. Gives users instant recognitions (maps items like Reinforcement concrete, for example). This may be the basic set for all data.
B) Map (system)—same as above but may be trained by software administrations with static fixed rules. These are taught vocabularies from specific software. Like Revit English, Revit German, DesignBuilder English, DesignBuilder Spanish, etc. These may be taught by importing a teaching file e.g. from the admin interface.
C) Warn—overrides recognitions and prevents training any new overriding hit (but does not prevent one-off mapping). Like “Default wall”—too generic to map; or if contains words like “Draft material”.
D) Discard—known items that must be taken out of the way, such as

“Empty”, “Beschichtung”, “Airspace”, “Ilmarako”, “Ilmavali”, “Luft”. This teaches software to always discard items with specific parameters like “Multiple sets of special pre-prepared system sets which are static. Multiple mappings may be made possible for the same entry. Thus, for example users can have their own mappings that override the settings of other users and there can be multiple mappings from multiple countries.

In an embodiment, system datasets may be trainable by selected users only, such as admin users. The training may be done by uploading datapoints to the system. Special learning rules like composite might be something that is only learned for a specific thickness as insulation etc. may vary.

In an embodiment, a user is able to see his preferences and adjust them via the user interface of the apparatus. It may be possible to consider user location preference for the data mapping as a weighting factor.

In an embodiment, recognition priority may be defined by a) user or organisation, b) country, c) narrowness. The system software shall propose functional equivalent from the same country if available.

In case of operating indicators data import (via specific importmapper), simultaneous multi-entity import is also possible. In such case the period has to be chosen and each datapoint has to have entity name.

In an embodiment, parametric optimization may be utilized. Parametric optimization means that the computer implemented method (e.g., algorithm) optimizes itself the solutions that work best for the project. Human operator only chooses the constraints within which the software performs the optimization.

Parametric optimization module for the computer implemented method (LCA system) assesses automatically a range of material options for building envelope and structure based on their life-cycle environmental impact and life-cycle cost. This allows besides choosing the most optimal material for the purpose, also optimizing insulation thickness in consideration of the local heating requirement and available heat supply impacts.

The analysis may be carried out on a cloud platform based on a range of pre-defined, as well as user-customisable, constructions. The analysis considers full life-cycle of materials as well as energy consumption during the building lifetime to provide user feedback for supporting decision making. The analysis may consider thermal performance of various materials for calculating the required heating for the envelope.

For example, a user determines that building location is in Seattle and that heating is based on local district heat that has specific environmental impacts as well as local heat rate. The user chooses a subset of available constructions for the benchmark and confirms their applicable rates represent specific prices. The user may further confirm assessment period length as well as applicable interest rate matching investor needs.

The computer implemented method (LCA system) may then process and calculate automatically a full range of options based on environmental and cost performance over the life-cycle, considering all retained options as well as variants in insulation applied to the project based on life-cycle cost of building and energy in use consumption, for example.

The end user may be provided both a visual summary as well as a detailed data table outlining performance of all considered options, for example.

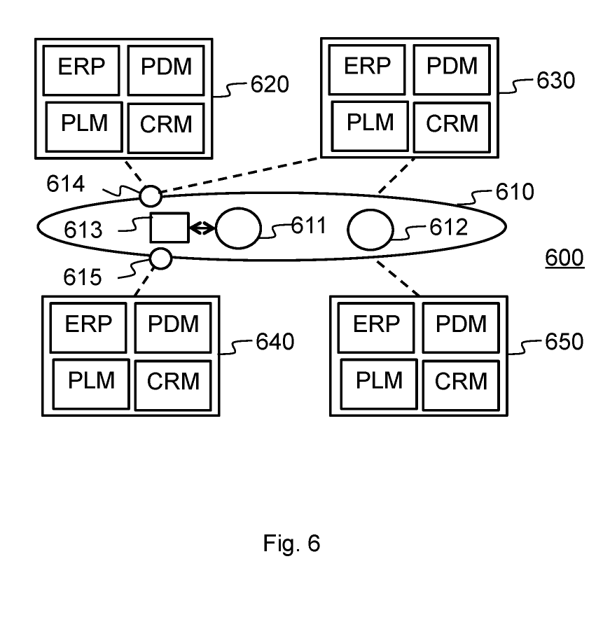

FIG. 6 shows an example block diagram of a network level information platform (NIP) 610 for a computer implemented method for generating sustainable performance and environmental impact assessment for a target system according to an example embodiment of the present disclosure.

In an embodiment, the network level information platform (NIP) 610 comprises information (relating to a user that may be a single user, company, organization or such) from a plurality of data sources, companies or organizations 620-650 that the user (company/organization) has a business relationship with. The companies 620-650 may be customer companies, and the companies 640-650 may be supplier companies, for example.

Each company 620-650 may have internal information systems, such as Enterprise Resource Planning system (ERP), Product Data Management system (PDM), Product Lifecycle Management system (PLM) and Customer Relationship Management system (CRM), for example.

The network level information platform (NIP) 610 does not need to replace all the existing systems but to provide information access and sharing for the LCA assessment, for example. The existing systems in the companies 620-650 may still be used for creating and storing information, as earlier.

In an embodiment the LCA related information may be provided to the network level information platform (NIP) 610 from the business relationship companies 620-650 and their internal information systems, such as Enterprise Resource Planning system (ERP), Product Data Management system (PDM), Product Lifecycle Management system (PLM) and Customer Relationship Management system (CRM) using various methods. The information may be provided manually, directly integrating a system to the platform 610, by using electronic data interchange (EDI) or by defining application programming interface (API), for example.

In an embodiment, LCA assessment modules 611-612 are provided by the network level information platform (NIP) 610 of a dynamic sustainable performance and environmental impact assessment system over a network or locally at the apparatus and configured to operate on business relationship information associated to at least two accounts of companies 620-650, wherein a LCA assessment module 611-612 is configured to generate at least one data entity 613 and dynamically sharing the at least one data entity 613 using at least one LCA assessment module 611-612 for the at least two accounts.

The dynamic business network and data management service system 600 is a non-hierarchical system for companies to share and manage information dynamically in their business relationships. In the system 600, a company is a basic unit and information is shared and owned by the companies 620-650, not by individual persons. Within the system, each personal account, if any, and profile may be assigned to a company account. Business relationships are the key elements in sharing information. Shared information is related to a specific business relationship, not internally to a specific company. When persons leave companies, the information remains creating a history for business relationship. Furthermore, the system 600 is a non-hierarchical system enabling dynamic information sharing. Every company 620-650 is the center of its own partner network. Traditionally a supplier might use or have an access to customers' own it-system. There might have been several same kinds of connections or accesses. In the present system 600, the system is not customers' own but the supplier can use the same systems with multiple customers and own suppliers. The system 600 is meant for business network management and dynamic information sharing. Every company 620-650 manages the portfolio of information whether the information is shared by them or to them. The information may be managed through modules 611-612 that are based on industry specific cross-company processes (orders, claims, audits, ideas, projects, etc.)

A company 620-650 can use the same system 600 with all partner companies whether they are vertically in a same supply chain or in co-operation horizontally with companies or any other organizations. By using the platform 610 the connections between companies 620-650 can be created by establishing online business relationships. In these relationships the information can be shared dynamically between one ore multiple companies 620-650 in non-hierarchical way (with any amount and any type of partner companies, whether they are customers, suppliers, units from same group or any other organizations). Thus, the system 600 provides fast and transparent industrial information sharing to business relationships and faster, user-friendlier and more efficient way to execute cross-company cooperation for LCA assessment.

Furthermore, group functionality provides a unique way to manage information within a specific business group comprised of one or more group accounts (different levels of the group organization) and sub-accounts (different group units like factories in different locations/countries under the same group). In FIG. 6 this could mean that the group company 620 (group account) can create internal relations with group units 630-650 (sub-accounts) and invite them to the same group hosted by the group account. In this way the users of the group account gain access to data entities 613 shared in these sub-accounts. And example could include group units (e.g. factories) in U.S., Canada and Mexico (sub-accounts 630-650) and one group account 620. The users of sub-accounts 630, 640 or 650 can see only the data entities 613 shared to the according sub-account 630, 640 or 650. The users of group account 620 can see all the data entities 613 shared to these three sub-accounts 630-650.

In an embodiment, the network level information platform (NIP) 610 may comprise LCA and sustainable performance application programming interface (API) 614-615. For example, an order from an ERP system of a customer 620 may be sent automatically via the API 614 to the network level information platform (NIP) 610. Supplier's 640 ERP system receives notification of the order and may automatically fetch the order via API 615. Furthermore, order confirmation from the supplier 640 ERP may be sent automatically via the API 615 to the platform 610 and delivered via the API 614 to the customer 620 ERP.

In an embodiment, an order from an ERP system of a customer 620 may be sent automatically via the API 614 to the network level information platform (NIP) 610. Supplier's 630 ERP system receives notification of the order and may automatically fetch the order via API 614. Furthermore, order confirmation from the supplier 630 ERP may be sent automatically via the API 614 to the platform 610 and delivered via the API 614 to the customer 620 ERP. Thus, different API 614, 615 may be used between customers and suppliers when communicating via the platform 610.

Various embodiments have been presented. It should be appreciated that in this document, words comprise, include and contain are each used as open-ended expressions with no intended exclusivity.

Without in any way limiting the scope, interpretation, or application of the claims appearing below, a technical effect of one or more of the example embodiments disclosed herein is improved sustainable performance and environmental impact assessment for a target system. Another technical effect of one or more of the example embodiments disclosed herein is improved speed for a LCA assessment for a target system. Another technical effect of one or more of the example embodiments disclosed herein is reduced cost for a LCA assessment for a target system. Another technical effect of one or more of the example embodiments disclosed herein is improved accuracy of a LCA assessment for a target system. Another technical effect of one or more of the example embodiments disclosed herein is improved input data usage of a LCA assessment for a target system.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the foregoing describes example embodiments of the invention, these descriptions should not be viewed in a limiting sense. Rather, there are several variations and modifications that may be made without departing from the scope of the present invention as defined in the appended claims.

1. A computer implemented method for generating sustainable performance and environmental impact assessment for a target system, comprising:
receiving input data associated with the target system;
converting the input data comprising raw material data to a universal system specification data format suitable for sustainable performance and environmental impact assessment;
receiving sustainable performance and environmental assessment rules of the target system;
generating assessment dataset containing a plurality of data items based on the converted input data;
determining applicable impact assessment data for each of the data items in the assessment dataset using dynamic adaptive recognition data comprising pre-configured recognition data;
applying the applicable impact assessment data for each of the data items in the assessment dataset to generate an impact dataset; and
determining sustainable performance and environmental impact assessment information of the target system using the sustainable performance and environmental assessment rules and the impact dataset.

2. The method of claim 1, wherein the dynamic adaptive recognition data further comprises user generated recognition data.

3. The method of claim 1, wherein the applicable impact assessment data are determined by selecting available impact assessment data that comply with the sustainable performance and environmental assessment rules of the target system.

4. The method of claim 1, wherein the dynamic adaptive recognition data comprises data recognition rules or patterns.

5. The method of claim 4, wherein the dynamic adaptive recognition data utilizes a plurality of different languages.

6. The method of claim 2, wherein the user generated recognition data comprises recognition patterns generated based on user behaviour.

7. The method of claim 1, further comprising:
scoring data recognition patterns of the dynamic adaptive recognition data to identify candidate data for determining the applicable impact assessment data, wherein the scoring utilizes user parameters comprising at least one of the following: geographical location information, user information and target system information.

8. The method of claim 1, further comprising:
determining if no applicable dynamic adaptive recognition data exist;
allowing a user to determine impact assessment data for the target system; and
generating dynamic adaptive recognition data using the user determined impact assessment data.

9. The method of claim 1, further comprising:
adjusting at least one data item of the applicable impact assessment data to generate adjusted impact assessment data, wherein the adjusted impact assessment data is configured to represent product or process impacts within applicable geographic location or specific process for the target system.

10. The method of claim 1, wherein unit of at least one data item of the assessment dataset is converted from a first unit to a second unit.

11. The method of claim 1, wherein the received input data associated with the target system comprises heterogeneous input data from a plurality of information sources.

12. The method of claim 11, wherein the heterogeneous input data comprises material data of a plurality of data formats.

13. The method of claim 1, further comprising:
detecting erroneous data items from the plurality of data items of the assessment dataset considering the sustainable performance and environmental assessment rules of the target system or a dynamic system data quality reference comprising rules and patterns.

14. The method of claim 13, further comprising:
correcting at least one error of the assessment dataset based on detected erroneous data items;
generating a corrected assessment dataset to replace the assessment dataset;
filtering the assessment dataset based on the sustainable performance and environmental assessment rules to generate filtered system specification data, wherein a portion of the assessment dataset that is not applicable for the sustainable performance and environmental assessment rules is removed; and
generating a filtered assessment dataset to replace the assessment dataset.

15. The method of claim 1, further comprising:
filtering the assessment dataset based on the sustainable performance and environmental assessment rules to generate filtered system specification data, wherein a portion of the assessment dataset that is not applicable for the sustainable performance and environmental assessment rules is removed; and
generating a filtered assessment dataset to replace the assessment dataset.

16. The method of claim 15, wherein unit of at least one data item of the assessment dataset is converted from a first unit to a second unit; and the method further comprising:
enhancing the assessment dataset based on the sustainable performance and environmental assessment rules of the target system or the dynamic system data quality reference comprising rules and patterns for classifying or adding assessment parameters to the data items.

17. The method of claim 1, further comprising:
scoring the applicable impact assessment data for fulfilling functional or technical criteria comprising at least one of the following: fire classification, accessibility classification, health-impacting emission classification, cost performance classification and climate resiliency classification.

18. The method of claim 10, wherein the received input data associated with the target system comprises heterogeneous input data from a plurality of information sources, and the method further comprising:
determining input data, consisting of data items wherein at least one of the data items is a composite data item configured to consist of multiple materials and to be broken down to constituent parts.

19. An apparatus comprising:
a communication interface;
at least one processor; and
at least one memory including computer program code;
the at least one memory and the computer program code configured to, with the at least one processor, cause the apparatus to:
receive input data associated with the target system;
convert the input data comprising raw material data to a universal system specification data format suitable for sustainable performance and environmental impact assessment;
receive sustainable performance and environmental assessment rules of the target system;
generate assessment dataset containing a plurality of data items based on the converted input data;
determine applicable impact assessment data for each of the data items in the assessment dataset using dynamic adaptive recognition data comprising pre-configured recognition data;
apply the applicable impact assessment data for each of the data items in the assessment dataset to generate an impact dataset; and
determine sustainable performance and environmental impact assessment information of the target system using the sustainable performance and environmental assessment rules and the impact dataset.

20. A computer program embodied on a computer readable non-transitory medium comprising computer executable program code, which when executed by at least one processor of an apparatus, causes the apparatus to:
receive input data associated with the target system;
convert the input data comprising raw material data to a universal system specification data format suitable for sustainable performance and environmental impact assessment;
receive sustainable performance and environmental assessment rules of the target system;
generate assessment dataset containing a plurality of data items based on the converted input data;
determine applicable impact assessment data for each of the data items in the assessment dataset using dynamic adaptive recognition data comprising pre-configured recognition data;
apply the applicable impact assessment data for each of the data items in the assessment dataset to generate an impact dataset; and
determine sustainable performance and environmental impact assessment information of the target system using the sustainable performance and environmental assessment rules and the impact dataset.
